(19) United States
(12) Patent Application Publication
(10) Pub. No.: US 2017/0097626 A1
(43) Pub. Date: Apr. 6, 2017

(54) METHOD FOR AUTOMATED CONTROL OF A MACHINE COMPONENT

(71) Applicant: BERNECKER + RAINER INDUSTRIE-ELEKTRONIK Ges.m.b.H., Eggelsberg (AT)

(72) Inventors: Franz KAUFLEITNER, Hochburg-Ach (AT); Miodrag VESELIC, Feldkirch (AT); Walter BURGSTALLER, Seeham (AT)

(73) Assignee: BERNECKER + RAINER INDUSTRIE-ELEKTRONIK Ges.m.b.H., Eggelsberg (AT)

(21) Appl. No.: 15/281,633

(22) Filed: Sep. 30, 2016

(30) Foreign Application Priority Data
Oct. 1, 2015 (AT) A50835/2015

(51) Int. Cl. G05B 19/042; G05B 11/01

(52) U.S. Cl. CPC G05B 19/0428; G05B 11/011; G05B 2219/50193; G05B 2219/34465

(57) ABSTRACT

The invention relates to a method for automated control of at least one machine component (1) in a plant (2). The machine component (1) is connected via a secure bus connection (6) to an automation component (7) by which it is controlled. The plant (2) has a safety area (4) monitored by means of at least one safety sensor (3), where a deviation of the measurement pattern (M) measured by the safety sensor (3) from a definition area (D) indicates a hazardous situation for protection objects (5), in particular persons and/or valuables. The machine component (1) triggers a protective action if a hazardous situation arises. The measurement patterns (M) measured by the safety sensor (3) are transmitted to the automation component (7) via the secure bus connection (6). The automation component (7) defines the definition area (D) using parameter data of the automated control, ascertains the presence of a hazardous situation, and activates the machine component (1) for performing the protective action.

This application claims priority under 35 U.S.C. §119(a) of Austrian Application No. A50835/2015 filed Oct. 1, 2015, the disclosure of which is expressly incorporated by reference herein in its entirety

The invention relates to a method for automated control of a least one machine component in a plant with an automation component, the machine component being linked to an automation component via a secure bus connection, the plant having a safety area monitored by means of at least one safety sensor and the machine component performing a protective action if a hazardous situation detected by the safety sensor for protection objects, in particular persons and/or valuables, arises.

The invention also relates to an automatization component for controlling at least one machine component in a plant.

Sensors for monitoring safety areas are used in safety-related applications. Sensors of this type can operate using optical methods (for example, light grid, photoelectric barrier, camera, laser scanner, etc.) using acoustical methods (for example, sound detectors), inductive methods, heat-sensitive methods or other methods.

When these sensors are used, there is a wide variety of information that an object in the protective field delivers, e.g. interrupted beams in the case of monitoring with a light grid, time-of-light values for a photoelectric barrier, image with a camera and similar. In safety-related applications aimed at keeping persons free from harm, the prior art currently uses only sensors which have their own evaluation unit and which transmit the measurement result as a single bit (i.e. as a truth value: hazardous situation present, yes/no) to a superordinate safety control, which then initiates further safety measures if necessary. Through this strong link between the evaluation of this information and the gathering of this information, only the reduced information “hazardous situation present” or “no hazardous situation present” remains for the superordinate safety control.

In particular, a “hazardous situation” is present only if an object worthy of protection, i.e. a person or a person's body part, but also other objects constituting valuables worthy of protection, is/are present in the safety area. Such objects worthy of protection are hereinafter referred to generally as objects to be protected. A hazardous situation can, however, also arise from a malfunction, for example, if parts of the machine component or other plant objects are not in their correct position. Plant objects can be regarded as all objects that are involved in the operating sequence of the machine component, i.e. not only the parts of the machine component itself, for example also products processed by the machine component.

Safety sensors, for example in the form of a light grid, must therefore be able to differentiate between plant objects that are in their intended position or motion from protection objects, the presence of which in the safety area requires a safety action. So that plant objects can nevertheless pass through the safety sensors, it is necessary to suppress individual sensors or, as the case may be, individual beams of the light grid for a defined duration of time when these plant objects pass through. A method in which the light grid is bypassed for a specific duration of time under certain conditions is known as muting. A method in which the individual beams of the light grid are suppressed (as not the entire light grid is bypassed) is known as blanking. In the case of a light grid sensor, the sensor is currently supplied with the appropriate information and the evaluation unit of the sensor decides whether an object to be protected is present in the safety area. This information—in general an individual bit—is then transmitted to a superordinate safety control, which then initiates further safety measures.

EP 1443343A2 discloses an optical sensor for safeguarding a monitoring area. The sensor has an evaluation unit which generates, as a function of the respective sensor measurement, switching signals, each of which deactivate certain work equipment. Protective fields can be defined in the monitoring area, each of which is assigned to safety switching outputs. The assignment of protective fields to the safety switching outputs can be defined prior to the optical sensor being put into operation. An application-specific combination of the individual beams with other process data, for example operating state of the machine, speed information of a motion, and positional information of machine parts, is not readily possible, but rather always requires time-consuming sensor programing to define the assignments.

With the prior art, the data measured by the sensor must always be “compressed” before it can be transmitted over a bus connection to an automatization device. This compression occurs on the basis of object recognition in the sensor itself.

To increase the complexity of the safety strategy, it would be possible with the prior art to provide the sensor with further signal units to enable the evaluation unit in the sensor to accommodate such signals and to factor them in during evaluation. However, the disadvantage of this, in turn, is that the sensor would possibly have to be equipped with a plurality of different signal units, thereby rapidly increasing the complexity of the sensor. Furthermore, the sensor has to be marketed in many different configurations to meet the various requirements economically. Additionally, when using a sensor, one is restricted to the available signal unit and, as user, cannot use any new combination that the sensor manufacturer has not yet taken into consideration. Each increase in assignment complexity manageable by the sensor thus requires an increase in the power of the evaluation unit and leads to an increase in overall cost.

To be able to use the information of the signal unit if necessary also in the remaining automation plant outside the sensor, the signal units would have to be double-wired if applicable.

The present invention seeks to solve the problem of furnishing a method with which it is possible to also implement complex safety strategies with relatively simple sensors. In addition, the method should facilitate a flexible definition of the particular safety strategy without the user being limited to the strategies taken into consideration by the sensor manufacturer.

These and further goals of the invention are achieved through a method of the type initially specified in which a measurement pattern measured by the safety sensor is transmitted over the secure bus connection to the automation component, the automation component ascertaining the presence of a hazardous situation on the basis of a measurement pattern and activating the machine component to perform a protective action. This allows safety strategies to be implemented independently of the evaluation unit of the safety sensor. Changing the safety strategy requires no reprograming of the sensor functions. Instead, the safety sensor can manage completely without an evaluation unit and thus be reduced to minimal complexity.

In contrast to “compressed” sensor information based on object recognition in the sensor, the measurement pattern contains uncompressed measurement data which only contains the information measured by the sensor and has not been linked with other data or parameters. In this context, “uncompressed” is understood to mean in particular data corresponding to the measurement data of the sensor prior to undergoing an object evaluation. The measurement pattern can constitute, for example, the pixel information of a safety sensor such as a light grid, essentially in its entirety. Uncompressed can also be understood to mean data, the information content of which has been reduced, such as when brightness values on the pixel level measured by the sensor are reduced to a binary statement (e.g., light grid beam interrupted/free).

In the context of the present invention, the term “safety strategy” describes the combination of rules and contexts that are provided for recognizing a hazardous situation and for executing appropriate protective actions in the plant.

In a preferred embodiment of the invention, the protective action can comprise a deactivation of at least parts of the machine component, the assumption of a protective position, an active reaction, for example the stopping of at least parts of the machine component, a change in the speed of at least parts of the machine component, an evasive movement, the triggering of a safety device such as an airbag or an extinguishing device, the triggering of an alarm or a combination thereof. It is advantageous here that the evaluation to determine whether an object worthy of protection is present in the protective area can be done not only independently of the sensor result, but rather that in the automation component all parameters of the automation solution can be taken into account for this evaluation.

Evaluating whether an object worthy of protection is present in the protective area is facilitated by an automated detection of a hazardous situation, wherein the hazardous situation can be defined as the detection of foreign objects or persons in the safety area, the detection of positional errors of machine component parts and/or the detection of positional errors of plant objects. According to the invention, the hazardous situation and the form of the protective actions tailored to the hazardous situation (which constitute a part of the safety strategy) can be adapted in a simple manner without requiring modifications to the sensor itself.

In an advantageous manner, the safety sensor can have at least one light grid arrangement. For example, light grids can be used for a finger protection with a beam spacing of roughly 14 mm, for a hand protection with a beam spacing of roughly 30 mm, for a body protection with a beam spacing of roughly 100 to roughly 300 mm and for an access protection with a beam spacing of roughly 400 to roughly 500 mm. These configuration variants are usually available commercially.

To achieve a higher grid resolution (i.e. smaller spacing between two grid beams lying next to one another) using an available light grid or with a standard beam distance, at least two light grid arrangements can be arranged in an advantageous manner parallel next to one another in relation to the grid plane and displaced from one another in relation to the longitudinal extension of their light sensors.

In another advantageous embodiment, at least one light grid arrangement can be arranged diagonally in relation to a direction of movement of a plant object. A plant object of defined form that passes through the light grid arrangement at a known velocity thereby generates a specific temporal sequence of the measurement pattern, which must be taken into account by the automation component for preventing an erroneous protective action. Through the diagonal position, it can be ensured that the plant object first enters the light grid at a precisely defined position. According to the invention, the interruption of the sensor at this point of entry can thus define the time of entry and be used as triggering event for a blanking or muting procedure.

In an advantageous embodiment of the invention, the automation component can ascertain the hazardous situation on the basis of the measurement pattern and using parameter data and/or process data of the control of the machine component or, as the case may be, the plant. The safety strategy can thus also be based on parameter data and/or process data of the plant, which allows expanded possibilities for implementing an advantageous safety strategy. The safety sensor also requires no interfaces whatsoever for receiving data. The stated tasks, including the implementation of complex safety strategies, can thus be performed according to the method specified in the invention with safety sensors that only have an interface for outgoing data communication.

In an advantageous embodiment according to the invention, the parameter data can, for example, be selected from an operating mode, geometric dimensions of machine parts or the presence of optional machine parts. The process data can be selected, for example, from a position, a speed and/or an acceleration of elements of the machine component and/or a position, a speed and/or an acceleration of drive means for a plant object. This allows the implementation of highly complex safety strategies that are optimally tailored to the particular conditions.

In an advantageous manner, the automation component can define a definition area, wherein a deviation of the measurement pattern or portion of this measurement pattern measured by the safety sensor and transmitted to the automatization component from the definition area indicates a hazardous situation. According to the invention, the automatization component can factor in a current or past measurement pattern of the safety sensor for ascertaining the definition area. The sensor can thus simultaneously be used for detecting plant objects and for the actual safety function. It is therefore not necessary to provide an additional sensor that can, for example, detect a plant object prior to entering a light grid.

In an advantageous manner, a certain change of the current or past measurement pattern triggers a defined temporal change of the definition area, thereby allowing complex rules for blanking or muting to be implemented. The changing definition area allows the plant object a (defined) passage through the light grid.

In an advantageous manner, the measurement pattern can be synchronously transmitted from the at least one safety sensor to the automation component via the secure bus connection. The measurement values of the various safety sensors on the bus can thereby be correctly arranged. In the context of the present application document, “synchronous” means that the measurement pattern or patterns of one or more safety sensors can be retrieved by a bus master of the secure bus connection and thereby be transmitted to the automation component “simultaneously”, i.e. within a cycle or time slot. The point in time of the measurement on which the measurement pattern is based is especially critical if the measurement pattern is reconciled with other process data of the plant and/or parameter data of the control. In conventional secure bus plants, a cycle is normally a defined length of approximately 200 μs to approximately 1 to 2 ms.

Alternatively, or additionally, the measurement data transmitted from the safety sensor to the automation component can each be provided with a time stamp. This allows the automatization component a precise temporal assignment of measurement patterns. The preferred solution depends on the particular specifications of the bus plant.

The automation component according to the invention for controlling at least one machine component in a plant advantageously has an interface via a secure bus connection to at least one safety sensor, the safety sensor monitoring a safety area and the safety sensor transmitting a measured measurement pattern to the automation component via the secure bus connection, the automation component evaluating the measurement pattern to ascertain the presence of a hazardous situation for protection objects, in particular persons and/or valuable, and, if a hazardous situation is present, activating the machine component for executing a protective action. An automation component of this type allows an advantageous implementation of the method according to the invention presented above. For this purpose, the automation component can have means designed for executing individual, multiple, or all steps of the method defined above.

In an advantageous manner, the automation component can ascertain the hazardous situation on the basis of the measurement pattern and using parameter data and/or process data of the control of the machine component or, as the case may be, the plant.

In a preferred embodiment, the automatization component can connect the measurement pattern obtained by the at least one safety sensor on the basis of temporal information with the parameter data and/or the process data.

In a more preferred manner, the automatization component can ascertain the temporal information of the measurement pattern on the basis of a synchronous transmission via the secure bus connection and/or on the basis of a time stamp.

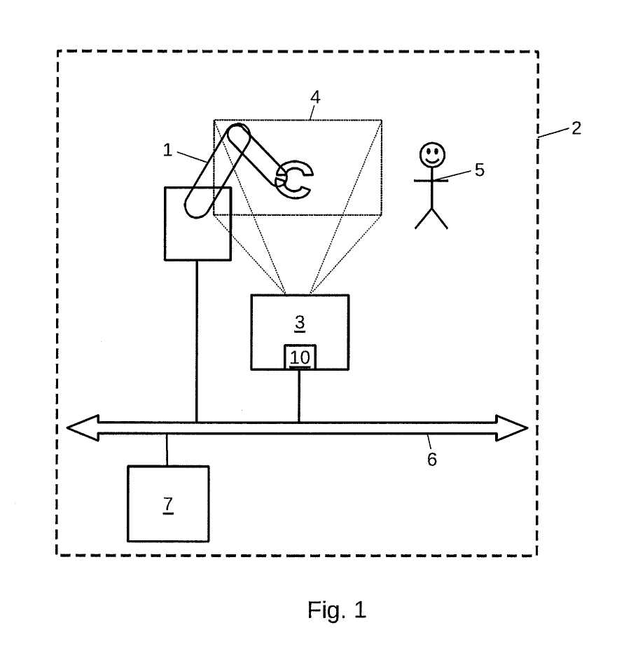

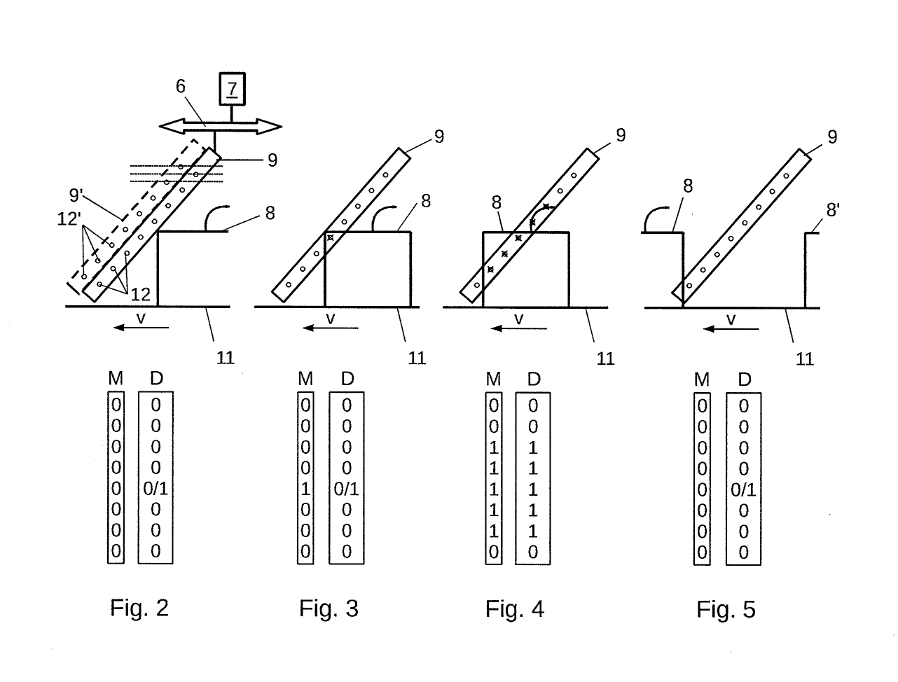

The present invention is explained in greater detail below using FIGS. 1 and 2, which schematically show advantageous configurations of the invention as examples without limiting its scope. Illustrated are

FIG. 1 a schematic representation of a plant in which the method according to the invention can be performed and

FIG. 2 through 5 the schematic sequence of a blanking or muting procedure according to an embodiment of the method according to the invention.

FIG. 1 presents the key elements of a plant 2 in which a machine component 1 is arranged. The machine component 1 can be, for example, any desired work machine or, as schematically illustrated in FIG. 1, a robot, wherein the moving parts of the machine component 1 define a safety area 4 in which the moving parts of the machine component 1 can pose a potential danger for the safety of a protection object 5, where the protection object 5 can be an operator, individual limbs or body parts of this operator, another plant object that can be present in the safety area 4, an object that constitutes an item of material value worthy of protection, or, in certain application scenarios, also an animal or a plant.

The safety area 4 is monitored by a safety sensor 3, where the safety sensor 3 can be realized, for example, as an optical sensor, for instance as a light grid, photoelectric barrier, camera, etc. as an acoustic sensor, as an inductive sensor or as a heat sensor. The sensor can also be realized as a combination of several of these sensor types, where either the entire safety area 4 or also only certain areas thereof, for example, the entrances and exits, can be monitored by the safety sensor 3.

If necessary, the plant can have a plurality of machine components 1 of the same or different type, each of which can define common or different, separate or overlapping safety areas 4. As would be clear to a person skilled in the art, multiple safety areas 4 can also be present in a plant, and a safety area can also be monitored by multiple safety sensors 3.

The machine component 1 is controlled via an automation component 7, which transmits over a bus connection 6 control commands to the machine component from which it receives feedback signals transmitted back over the bus connection 6.

The bus connection preferably functions according to a secure bus protocol, for example openSAFETY, ProfiSafe, CIPsafety, etc. This makes it possible for safety technology data to be exchanged between the safety-related plant components with high performance, large bandwidth and still in accordance with the applicable safety standards.

In general, all bus plants satisfying the requirements related to transmission security stipulated in IEC 61784-3 or IEC 61508 can be used as secure bus connection 6.

The safety sensor 3 features, in addition to the known sensor plant for monitoring the safety area 4, a communication interface 10, via which the measurement pattern M recorded by the safety sensor 3 is transmitted to the automation component 7 via the bus connection 6. If necessary, the communication interface 10 can also comprise a function for receiving control data for the sensor. However, this is not a requirement of the method according to the invention. A one-way communication interface 10 that is suitable only for transmitting data over the bus connection 6 can therefore suffice.

“Measurement pattern” M describes the entirety of all measurement values recorded by the safety sensor at a specific point in time, where in the case of binary values (i.e. for instance: light grid interrupted/not interrupted) the measurement pattern can be indicated as a binary number that directly represents the measurement pattern M. For example, the measurement pattern M of a light grid with eight light grid beams can be indicated in the form of an 8-bit binary number. Depending on sensor type, the measurement pattern M, however, can also contain other measurement values, for instance continuously adjustable values (for example temperature, ((acoustic)) pressure, induction, acceleration, etc.).

In contrast to the safety sensors of the prior art, the safety sensor 3 does not require an evaluation unit that evaluates the measurement pattern M and thereby generates an individual 1-bit measurement value that is indicative of the presence of a hazardous situation. This also eliminates the often considerable effort required for the application-specific programming of the evaluation units of safety sensors. Also not required is an interface via which the safety sensor 3 receives information from the automation component 7, for instance for controlling muting or blanking procedures. The method according to the invention can thus be executed with a safety sensor 3 of extremely simple construction.

The safety sensor 3 transmits to the automation component 7 the measurement pattern M usually at a specific pulsing, which can be tuned to the other components of the plant 2, i.e. for instance the bus connection 6, the automation component 7 or the machine component 1. The automation component 7 has at its disposal all relevant parameter data required for controlling the machine component 1 and, if necessary, for coordinating with other machine elements present in the plant 2. The automation component 7 is thus able to evaluate the measurement pattern M received from the safety sensor 3 (or a plurality of safety sensors 3) and combine it with the particular machine state of the machine component 1. Complex safety strategies can thus be implemented independently and can be adapted as desired without replacing the safety sensor 3. It is also possible to combine the data of the safety sensor with other data of the safe process in a secure control. This allows the programming of application-specific scenarios that are not limited to possibilities rigidly prescribed in the sensor.

An exemplary use of the method according to the invention is explained below using FIG. 2 through 5, these figures illustrating the use of a light grid arrangement 9 for securing an area above a conveyor belt 11, which transports plant objects 8 through the light grid arrangement 9 at a speed v. For this purpose, the light grid arrangement 9 can serve to, for example, stop the conveyor belt 11 if a foreign object makes its way into the area of the light grid arrangement (for instance, if an operator reaches inside) or if one of the plant objects 8 is not arranged in a defined position on the conveyor belt 11 or if the conveyor belt 11 transports an “incorrect” object.

FIG. 2 shows a light grid arrangement 9 with eight light sensors 12, so that the light grid arrangement 9 has eight light grid beams arranged parallel to one another, the plant object 8 (for example, a workpiece being processed) arranged on the conveyor belt being present in a position just before the entrance into the light grid. The light grid arrangement 9 can, for example, define and monitor an entrance or an exit into or out of a safety area.

FIG. 2 illustrates as an example the arrangement of a second light grid arrangement 9′ indicated in dashed lines, which is essentially identical to the first light grid arrangement 9, yet is arranged parallel (in relation to the light grid plane) next to the first light grid arrangement 9. The light sensors 12′ of the second light grid arrangement 9′ are arranged displaced from the light sensors 12 of the first light grid arrangement 9 relative to the longitudinal extension of the light grid arrangement 9, 9′ such that the vertical spacing between two light sensors 12 of the first light grid arrangement 9 is in each case effectively cut in half by the additional light sensors 12′ of the second light grid arrangement 9′. This is illustrated in FIG. 2 by the dotted lines. In this way, measurement resolution can be doubled (or the grid spacing of the light grid cut in half). For the sake of clarity, the description is continued without taking into consideration a second light grid arrangement of this type.

The measurement pattern M of the light grid arrangement 9 can be represented as an 8-bit binary number, where each bit corresponds to a light sensor 12 and where in the case illustrated each interrupted light grid is assigned a 1. Because none of the light grid beams are interrupted in the position illustrated in FIG. 2, a measurement pattern M=00000000 results. The measurement pattern is transmitted at a specific pulsing from the light grid arrangement 9 (which in relation to FIG. 1 corresponds to the safety sensor 3) to the automation component 7 via the bus connection 6.

In FIG. 2 a definition area D, which can likewise be represented as a binary number or as a group of binary numbers, is contrasted with the measurement pattern M. The definition area is ascertained and administered by the automation component 7. In FIG. 2 the definition area D consists of the amount {00000000, 00001000}. The automation component 7 compares whether the current measurement pattern M falls in the definition area D or coincides with it, as the case may be. If this is not the case, the automation component recognizes the presence of a hazardous situation and triggers an emergency stop of the conveyor belt 11 (here the conveyor belt 11 essentially corresponds to the machine component 1 in FIG. 1). If necessary, another suitable protective action can also be performed instead of the emergency stop, for instance, deceleration of the speed v and/or triggering an alarm, etc.

The second binary number of the definition area D presented above enables a light grid beam of the light grid arrangement 9 (the fourth light grid beam when viewed from below) to be interrupted without it triggering a protective action. As illustrated in FIG. 3, this corresponds to the situation when a plant object 8 conveyed by the conveyor belt 11 enters the light grid positioned diagonally in relation to the direction of movement of the plant object 8. While the interruption of this light grid beam thus triggers no protective action, it is registered by the automation component 7 (which for the sake of clarity is not shown in FIG. 3 through 5) as an event that identifies the entrance of a plant object 8.

The automation component 7 possesses, on one hand, all parameter data of the automated control and, on the other hand, also knows other process data (e.g. sensor and feedback data) of the controlled machine component 1. In the example kept very simple in FIG. 2 through 5, the particular speed v (which is controlled by the automation component 7) is known to the automation component 7, so that the automation component 7 can ascertain in a simple manner which light grid beams are interrupted in the next time segments by a plant object 8 correctly arranged on the conveyor belt 11. The plant object 8 should now be transported through the light grid without a protective action being triggered. If the automation component 7 detects the change in measurement pattern M from 00000000 to 00001000 (FIG. 2 to FIG. 3), it triggers a temporal sequence of changes in definition area D precisely harmonized with the plant object and the speed v thereof, where at each point in time exactly the light sensors 12 of the light grid arrangement 9 are “suppressed” through corresponding setting of the bits of definition area D, the light grid beams of which sensors are interrupted precisely by the plant object 8. This is illustrated in FIG. 4 as an example.

If the plant object 8 has been transported through the light grid (FIG. 5), the automation component 7 return the definition area D to the starting state until a further plant object 8′ enters the photoelectric barrier and the next blanking or muting procedure is triggered.

If the automation component 7 also possesses, in addition to the speed v of the conveyor belt 11, data on the exact position of the plant objects 8, 8′ on the conveyor belt 11, the light grid can also be completely “closed” outside the blanking or muting procedures (i.e. definition area D=00000000).

In addition to speed v and position data, numerous other parameter and/or process data can be used by the automation component depending on application to implement safety strategies of desired complexity. For example, position, speed and/or acceleration data in various axial directions can be used, for example to monitor spatial movements of machine components, for instance robots or transport cranes, and other objects through complex spatially defined safety areas.

The method according to the invention is particularly suited for all areas in which automation plants are employed and where safety-related precautions must be taken to protect persons and objects. In particular, the method according to the invention serves to protect persons in industrial plants controlled via an automation plant from bodily harm.

### REFERENCE NUMBERS

Machine component 1
Plant 2
Safety sensors 3
Safety zone 4
Protection object 5
Bus connection 6
Automation component 7
Plant object 8
Light grid arrangement 9, 9′
Communication interface 10
Conveyor belt 11
Light sensor 12, 12′

1. Method for automated control of a least one machine component (1) in a plant (2) with an automation component (7), the machine component (1) being linked to an automation component (7) via a secure bus connection (6), the plant (2) having a safety area (4) monitored by means of at least one safety sensor (3) and the ma-chine component (1) performing a protective action if a hazardous situation detected by the safety sensor (3) for protection objects (5), in particular persons and/or valuables, arises, characterized in that a measurement pattern (M) measured by the safety sensor (3) is transmitted over the secure bus connection (6) to the automation component (7), the automation component (7) ascertaining the presence of a hazardous situation on the basis of a measurement pattern (M) and activating the machine component (1) to perform a protective action.

2. The method according to claim 1, characterized in that the protective action comprises a deactivation of at least parts of the machine component (1), the assumption of a protective position, an active reaction, for example the stopping of at least parts of the machine component (1), a change in the speed of at least parts of the ma-chine component (1), an evasive movement, the triggering of a safety device such as an airbag or an extinguishing device, the triggering of an alarm or a combination thereof.

3. The method according to claim 1, characterized in that hazardous situation is defined as the detection of foreign objects or persons in the safety area (4), the detection of positional errors of machine component (1) parts and/or the detection of positional errors of plant objects (8).

4. The method according to claim 1, characterized in that the safety sensor (3) has at least one light grid arrangement (9).

5. The method according to claim 4, characterized in that at least two light grid arrangements (9, 9′) can be arranged parallel next to one another in relation to the grid plane and displaced from one another in relation to the longitudinal extension of their light sensors.

6. The method according to claim 4, characterized in that at least one light grid arrangement (9) is arranged diagonally in relation to a direction of movement of a plant object (8).

7. The method according to claim 1, characterized in that the automation component (7) ascertains the hazardous situation on the basis of the measurement pattern (M) and using parameter data and/or process data of the control of the machine component (1) or, as the case may be, the plant (2).

8. The method according to claim 7, characterized in that the process data is selected from a position, a speed and/or an acceleration of elements of the machine component (1) and/or a position, a speed and/or an acceleration of drive means for a plant object (8).

9. The method according to claim 7, characterized in that the parameter data is selected from an operating mode, geometric dimensions of machine parts and/or the presence of optional machine parts.

10. The method according to claim 1, characterized in that the automation component (7) defines a definition area (D), wherein a deviation of the measurement pattern (M) or a portion of this measurement pattern (M) measured by the safety sensor (3) and transmitted to the automatization component (7) from the definition area (D) indicates a hazardous situation.

11. The method according to claim 10, characterized in that the automatization component (7) factors in a current or past measurement pattern (M) of the safety sensor (3) for ascertaining the definition area (D).

12. The method according to claim 11, characterized in that a certain change in the current or past measurement pattern (M) triggers a defined temporal change of the definition area (D).

13. The method according to claim 1, characterized in that the measurement pattern (M) is transmitted synchronously from the at least one safety sensor (3) to the automation component (7) via the secure bus connection (6).

14. The method according to claim 1, characterized in that the data transmitted from the safety sensor (3) to the automation component (7) are each provided with a time stamp.

15. Automation component (7) for controlling at least one machine component (1) in a plant (2), characterized in that the automation component (7) has an interface via a secure bus connection (6) to at least one safety sensor (3), the safety sensor (3) monitoring a safety area (4) and the safety sensor (3) transmitting a measured measurement pattern (M) to the automation component (7) via the secure bus connection (6), the automation component (7) evaluating the measurement pattern (M) to ascertain the presence of a hazardous situation for protection objects (5), in particular persons and/or valuable, and, if a hazardous situation is present, activating the machine component (1) for executing a protective action.

16. The automation component (7) according to claim 15, characterized in that the hazardous situation is ascertained on the basis of the measurement pattern (M) and using parameter data and/or process data of the control of the machine component (1) or, as the case may be, the plant (2).

17. The automation component (7) according to claim 16, characterized in that the automatization component (7) connects the measurement pattern (M) obtained by the at least one safety sensor (3) on the basis of temporal information to the parameter data and/or the process data.

18. The automation component (7) according to claim 17, characterized in that the temporal information of the measurement pattern (M) is ascertained on the basis of a synchronous transmission via the secure bus connection (6) and/or on the basis of a time stamp.
